(19) United States
(12) Patent Application Publication
(10) Pub. No.: US 2015/0367369 A1
(43) Pub. Date: Dec. 24, 2015

(54) Sprinkler Head Concealment Assembly

(71) Applicant: Lowry Wood, JR., Danville, CA (US)

(72) Inventor: Lowry Wood, JR., Danville, CA (US)

(21) Appl. No.: 14/308,917

(22) Filed: Jun. 19, 2014

(51) Int. Cl. B05B 15/00; E01C 13/08

(52) U.S. Cl. CPC B05B 15/001; E01C 13/08

(57) ABSTRACT

A sprinkler head concealment assembly for concealing the sprinkler head when the sprinkler head is not being utilized includes a cap that may be positioned on a top end of the sprinkler head. A concealing layer is coupled to the cap. The concealing layer resembles plant life. The sprinkler head is concealed from an observer when the sprinkler head is in a support surface.

### BACKGROUND OF THE DISCLOSURE

### Field of the Disclosure

The disclosure relates to concealment devices and more particularly pertains to a new concealment device for concealing a sprinkler head when the sprinkler head is not being utilized.

### SUMMARY OF THE DISCLOSURE

An embodiment of the disclosure meets the needs presented above by generally comprising a cap that may be positioned on a top end of a sprinkler head. A concealing layer is coupled to the cap. The concealing layer resembles plant life. The sprinkler head is concealed from an observer when the sprinkler head is in a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a sprinkler head concealment assembly according to an embodiment of the disclosure.

FIG. 2 is a bottom view of an embodiment of the disclosure.

FIG. 3 is a right side view of an embodiment of the disclosure.

FIG. 4 is a top view of an embodiment of the disclosure.

FIG. 5 is an in-use view of an embodiment of the disclosure.

FIG. 6 is a schematic view of a method of utilizing an embodiment of the disclosure.

### DESCRIPTION OF THE PREFERRED EMBODIMENT

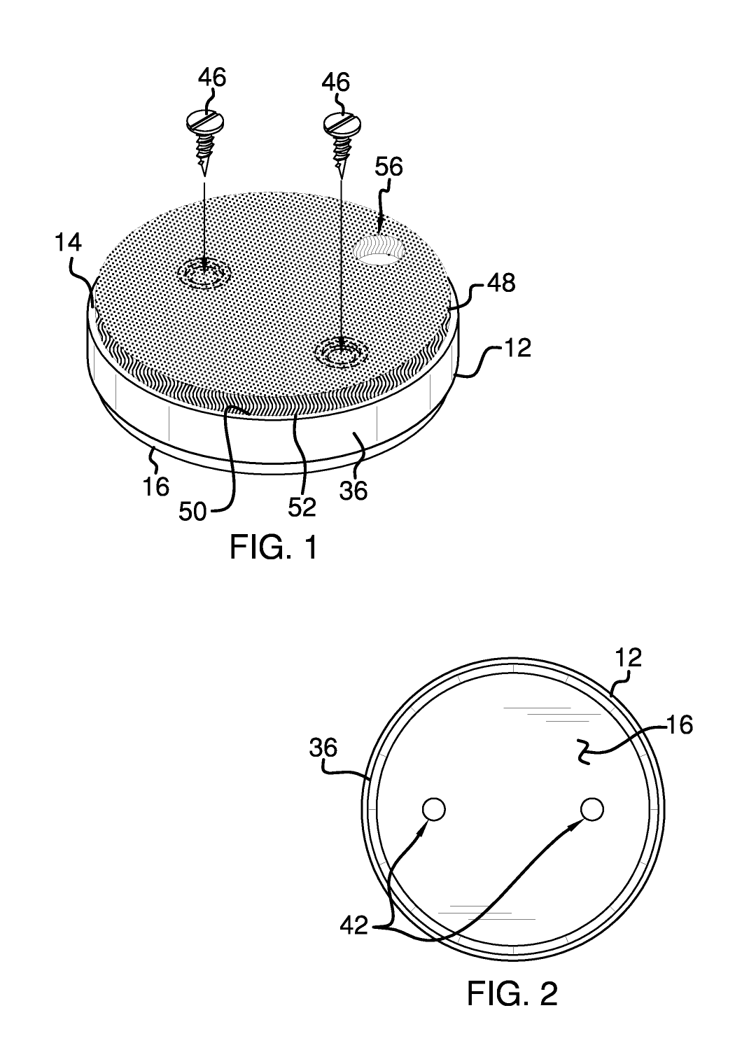

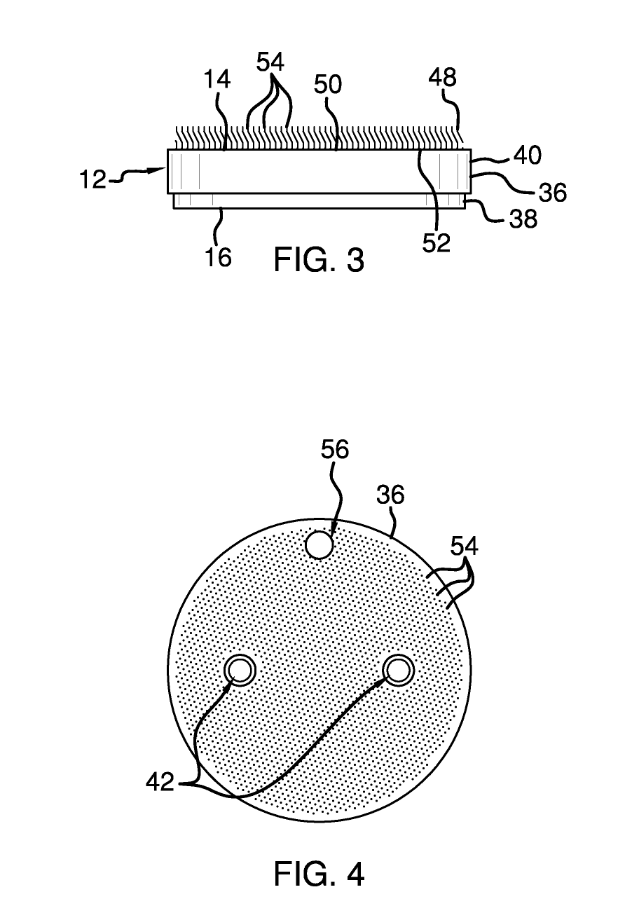

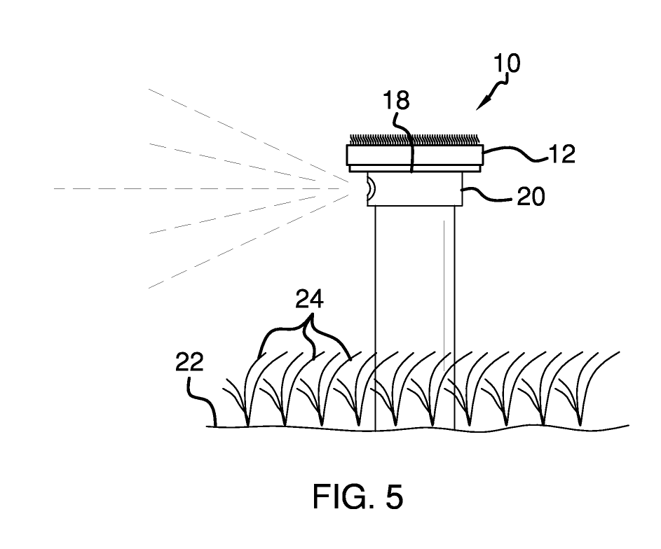

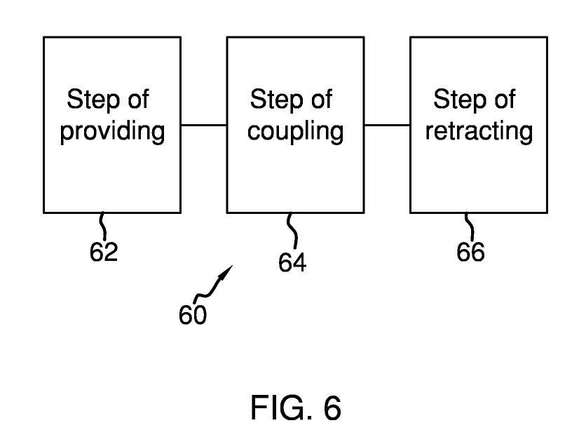

With reference now to the drawings, and in particular to FIGS. 1 through 6 thereof, a new concealment device embodying the principles and concepts of an embodiment of the disclosure and generally designated by the reference numeral 10 will be described.

As best illustrated in FIGS. 1 through 6, the sprinkler head concealment assembly 10 generally comprises a cap 12 that has a top surface 14 and a bottom surface 16. The cap 12 is positionable on a top end 18 of a sprinkler head 20. The bottom surface 16 of the cap 12 abuts the top end 18 of the sprinkler head 20. The sprinkler head 20 may be a retracting sprinkler head of any conventional design.

The sprinkler head 20 may be movably positioned within a support surface 22. The support surface 22 may be ground. Additionally, the sprinkler head 20 may be surrounded by plant life 24. The plant life 24 may be grass of any species.

An outer edge 36 of the cap 12 extends between the top 14 and bottom 16 surfaces of the cap 12. The outer edge 36 of the cap 12 is curvilinear. The cap 12 has a disk shape. A lower portion 38 of the outer edge 36 of the cap 12 is positioned inwardly from an upper portion 40 of the outer edge 36 of the cap 12.

The cap 12 has a pair of fastener apertures 42 extending through the top 14 and bottom 16 surfaces of the cap 12. Each of the pair of fastener apertures 42 is evenly spaced apart from a center 44 of the cap 12. A pair of fasteners 46 extends through an associated one of the pair of fastener apertures 42 and engages the top end 18 of the sprinkler head 20. The cap 12 is retained on the top end 18 of the sprinkler head 20. The pair of fasteners 46 may each be a screw of any conventional design.

A concealing layer 48 is provided. The concealing layer 48 has an upper side 50 and a lower side 52. The lower side 52 of the concealing layer is coupled to the top surface 14 of the cap 12. Additionally, the concealing layer 48 completely covers the top surface 14 of the cap 12. The concealing layer 48 has a plurality of fingers 54 extending upwardly from the upper side 50 of the concealing layer 48. Moreover, the plurality of fingers 54 completely covers the upper side 50 of the concealing layer 48. The plurality of fingers 54 resembles the plant life 24.

A finger hole 56 extends through the upper 50 and lower 52 sides of the concealing layer 48. The finger hole 56 is positioned proximate an exterior edge 58 of the concealing layer 56. The finger hole 56 may be gripped to remove the cap 12 from the sprinkler head 20. The plurality of fingers 54 on the concealing layer 48 is positioned within the plant life 24 on the support surface 22 when the sprinkler head 20 is retracted into the support surface 22. The concealing layer 48 conceals the sprinkler head 20 from an observer when the sprinkler head 20 is retracted into the support surface 22.

In use, a method 60 of concealing the sprinkler head 20 when the sprinkler head 20 is retracted into the support surface 22 includes a step 62 of providing the cap 12 coupled to the top end 18 of the sprinkler head 20 and the concealing layer 48 that has the plurality of fingers 54. The method 60 additionally includes a step 64 of coupling the cap 12 to the top end 18 of the sprinkler head 20. Continuing, the method 60 includes a step 66 of retracing the sprinkler head 20 into the support surface 22 so the plurality of fingers 54 is positioned within the plant life 24 on the support surface 22. The plurality of fingers 54 conceals the sprinkler head 20 from the observer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sprinkler head concealment assembly configured to conceal the sprinkler head when the sprinkler head is not being utilized, said assembly comprising:
a cap configured to be positioned on a top end of the sprinkler head; and
a concealing layer coupled to said cap, said concealing layer resembling plant life such that the sprinkler head is concealed from an observer when the sprinkler head is in a support surface.

2. The assembly according to claim 1, wherein said cap having a top surface and a bottom surface, said cap being positionable on the top end of the sprinkler head such that said bottom surface of said cap abuts the top end of the sprinkler head.

3. The assembly according to claim 2, wherein said cap having a pair of fastener apertures extending through said top and bottom surfaces of said cap, each of said pair of fastener apertures being evenly spaced apart from a center of said cap.

4. The assembly according to claim 3, wherein a pair of fasteners extends through an associated one of said pair of fastener apertures and engages the top end of the sprinkler head such that said cap is retained on the top end of the sprinkler head.

5. The assembly according to claim 2, wherein said concealing layer having an upper side and a lower side, said lower side of said concealing layer being coupled to said top surface of said cap.

6. The assembly according to claim 5, wherein said concealing layer having a plurality of fingers extending upwardly from said upper side of said concealing layer, said plurality of fingers completely covering said upper side of said concealing layer such that said plurality of fingers resembles the plant life.

7. The assembly according to claim 6, wherein said plurality of fingers on said concealing layer being positioned within the plant life on the support surface when the sprinkler head is retracted into the support surface.

8. A sprinkler head concealment assembly configured to conceal the sprinkler head when the sprinkler head is not being utilized, said assembly comprising:
a cap having a top surface and a bottom surface, said cap being positionable on the top end of the sprinkler head such that said bottom surface of said cap abuts the top end of the sprinkler head;
said cap having a pair of fastener apertures extending through said top and bottom surfaces of said cap, each of said pair of fastener apertures being evenly spaced apart from a center of said cap;
a pair of fasteners extends through an associated one of said pair of fastener apertures and engages the top end of the sprinkler head such that said cap is retained on the top end of the sprinkler head;
a concealing layer, said concealing layer having an upper side and a lower side, said lower side of said concealing layer being coupled to said top surface of said cap;
said concealing layer having a plurality of fingers extending upwardly from said upper side of said concealing layer, said plurality of fingers completely covering said upper side of said concealing layer such that said plurality of fingers resembles plant life; and
said plurality of fingers on said concealing layer being positioned within the plant life on the ground when the sprinkler head is retracted into a support surface.

9. A method of concealing a sprinkler head when the sprinkler head is retracted into the ground, the steps of the method comprising:
a step of providing said cap coupled to the top end of the sprinkler head and said concealing layer having said plurality of fingers;
a step of coupling said cap to the top end of the sprinkler head;
a step of retracing the sprinkler head into the ground such that said plurality of fingers is positioned within plant life on a support surface, said plurality of fingers concealing the sprinkler head from an observer.
